(19) United States
(12) Patent Application Publication
(10) Pub. No.: US 2006/0016097 A1
(43) Pub. Date: Jan. 26, 2006

(54) Moisture removal device

(76) Inventor: Kuo Ching Chiang, Taoyuan City (TW)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/898,761

(22) Filed: Jul. 26, 2004

(51) Int. Cl. H05B 1/02; F26B 19/00

(52) U.S. Cl. 34/549; 219/497

(57) ABSTRACT

The present invention discloses a moisture removal device includes a transparent conductive pattern attached partially on an object, wherein the material for the conductive pattern includes oxide containing metal or alloy, a power source is coupled to the conductive pattern for providing heat to the conductive pattern to remove fog or moisture on the object. An additional passive layer can be added to protect the conducting layer. Materials for this passivation layer are made, for instance, of oxide, or any other polymeric material, polymer, resin coating on the structure.

### FIELD OF THE INVENTION

The present invention relates a means for removing moisture, and more particularly, a moisture removal device with a conductive transparent layer coated on an object to remove moisture on the object.

### BACKGROUND OF THE INVENTION

Driving in rainy weather presents problems of visibility, it is because that the water droplets, moistures are deposited on the surface of the rear windshield or the reflective surfaces of external rear view mirrors. Thus, the vehicle wind glass needs a device for removing condensation from windows in vehicle windshield or mirror. The rear windshield or rearview mirrors are commonly located at suitable position to allow the driver to view traffic in the lane. The windows have a tendency of fogging to the accumulation of moisture. Water vapor will tend to condense on the inner pane of the outer view window. It can turn to frost in the winter. It is also happen on the glass of a door panel of a freezer for cold storage. If the moisture is condensation on the glass, the customer is unlikely see through the glass, thereby causing visibility problems. In the past, the available way was wiping the mirror manually. While wiping the driver's side mirror might be accomplished expeditiously, wiping the rear windshield is impossible, otherwise, it required a stop. Both scenarios are time consuming and possibly hazardous. U.S. Pat. No. 4,979,809 disclosed respective air scoops for a mirror assembly. The usage of some metal lines attached on the windshield for removing the moisture is well known in the art. The metal lines may be copper, alloy or the like. However, the metal traces are not optical transparent. It will also cause the problems of visibility. None of the prior arts is seen to disclose a simplistic, inexpensive device as will subsequently be described and claimed in the instant invention.

### SUMMARY OF THE INVENTION

A purpose of the invention is to provide a means for an object that allows for removal of moisture and condensation on the glass without the need for any external fan and allows for minimum reduction of visibility through the window due to moisture. The object includes a vehicle windshield, wind glass or a vehicle rearview mirror or glass door panel of a freezer or the glass portion of the freezer, wherein the transparent conductive pattern is attached at least partially one side such as the interior of the vehicle windshield or on the vehicle rearview mirror or on one side of the glass of the freezer. The transparent conductive pattern includes oxide containing metal, wherein the metal is at least picked from Au, Ag, In, Ga, Al, Sn, Ge, Sb, Bi, Zn, Pt and Pd. The method for forming the conductive pattern comprises preparing a coating solution containing metal particles, then coating the solution on a substrate to form a layer; drying the layer; and baking the layer to obtain a transparent conductive pattern.

The present invention further discloses a conductive pattern comprising: a plurality of strips attached partially on an object, wherein the material for the conductive pattern includes oxide containing metal, the metal being preferable to select one or more metals from the aforementioned group, a power coupled to the conductive pattern for providing heat or electrical current flowing through the conductive pattern to remove fog or moisture on the object. The transparent materials may be formed by sputtering vacuum deposition process. An additional passive layer can be added to protect the conducting layer. Materials for this passivation layer are made, for instance, of oxide, or any other polymeric material, polymer, resin coating on the structure. The method for forming the transparent conductive layer includes ion beam method at low temperature, see 1999, IEEE, 1191. U.S. Pat. No. 6,743,476 disclosed a method of producing thin film electrode at room temperature. Both of the ion beam and sputter is expensive. During the formation process, the present invention suggested one known method that involves a mask can be placed on the substrate material to obtain the desired shape or pattern. This mask normally is made of conducting material such as stainless steel or copper, or a photosensitive material to create the mask by photochemical processes. Then, the pattern can be “print” on the desired object. Thus, the sputter process can be replaced by the chemical solution coating.

The moisture removal device further comprises a controller coupled to the switch. The controller includes a sensor to detect a parameter of the object. A comparator is responsive to the detected data and compares the detected data to a predetermined reference value. A driver is coupled to the comparator to turn on said switch, wherein when the detected data excesses the predetermined reference parameter, otherwise, turns off said switch. The parameter includes the temperature of the glass, the moisture around the glass, or the resistance of the metal strips.

### BRIEF DESCRIPTION OF THE DRAWINGS

The novel features believed characteristic of the invention are set forth in the appended claims. The present invention will best be understood by reference to the description in conjunction with the accompanying drawings, wherein:

FIG. 1 is a functional diagram of a vehicle containing moisture removal device including transparent conductive pattern formed on a windshield or door panel window in accordance with this invention;

FIG. 2 is a functional diagram of a freezer containing moisture removal device including transparent conductive pattern formed on a glass or door panel window in accordance with this invention;

FIG. 3 is a functional diagram of a controller of the moisture removal device in accordance with this invention.

FIG. 4 is a illustrator showing the example of the conductive strips in accordance with this invention.

### DETAILED DESCRIPTION OF THE PREFERRED EMBODIMENTS

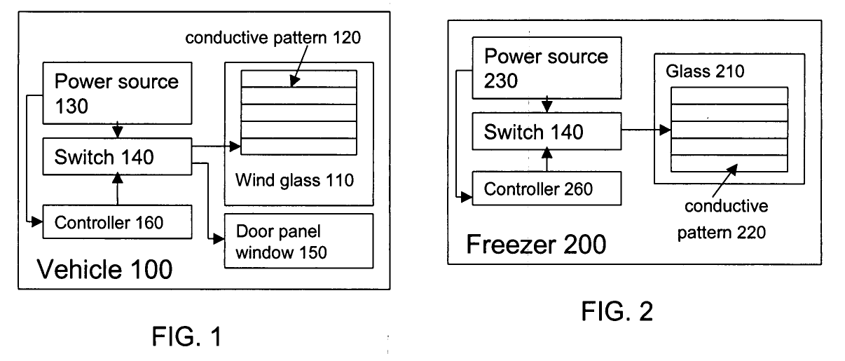

The present invention describes means for removing moisture on an object, for example window, glass or the like. See FIGS. 1, 2, and 3. The vehicle 100 has a rear windshield 110, door panel window 150 and a rearview mirror (not shown). The rear windshield 110 or the door panel window 150 has a conductive pattern or traces 120 located thereon. The pattern 120 may be a constructed by geometry figures, preferably, a plurality of strips connected together at both terminals. I should be noted, any configuration could be patterned to achieve the purpose. A power source 130 is coupled to the conductive pattern or traces 130 via a switch 140 to provide heat or power for removal the moisture on the object. The power could be provided by the battery of the vehicle for an example. In the example of the freezer 200 (refer to FIG. 2), electric power source 230 can be provided to the freezer, thereby conducting electricity to the conductive pattern or traces 220 on the glass 210 of the freezer 200. The result is that heat removes the moisture on the object. The electric current provided by the power source 230 via a switch 240 flows across the conductive pattern or traces 130 that result in removal of any condensation on the windowpanes. The result is improved visibility through the window or windshield. The conductive pattern or traces 130 or 230 may be encapsulated by a material. Alternatively, the substantially entire surface can be coated with the material for conductive and transparent.

FIG. 1-3 describes a preferred embodiment of the present invention, the means for removing moisture comprising a transparent conductive pattern coated on an object, the example of the object includes but not limited to windshield, wind glass, rearview mirror of a vehicle, a glass window of a building, glass door of an exhibition closet or the freezer. The pattern includes any type of geometry configuration. In a preferred example, please refer to FIG. 4, the pattern 120 could be constructed by a plurality of strips 125 which form a close loop. A power source 130 via a switch 140 is coupled to the conductive pattern via conductive lines. A heat may be provided to the transparent conductive pattern via a power source, such as electric power. The power is coupled to the configuration for providing electrical current flowing through the transparent conductive pattern to remove or reduce the moisture on the glass. The shape of the transparent conductive pattern could be polygonal, band, strip or line.

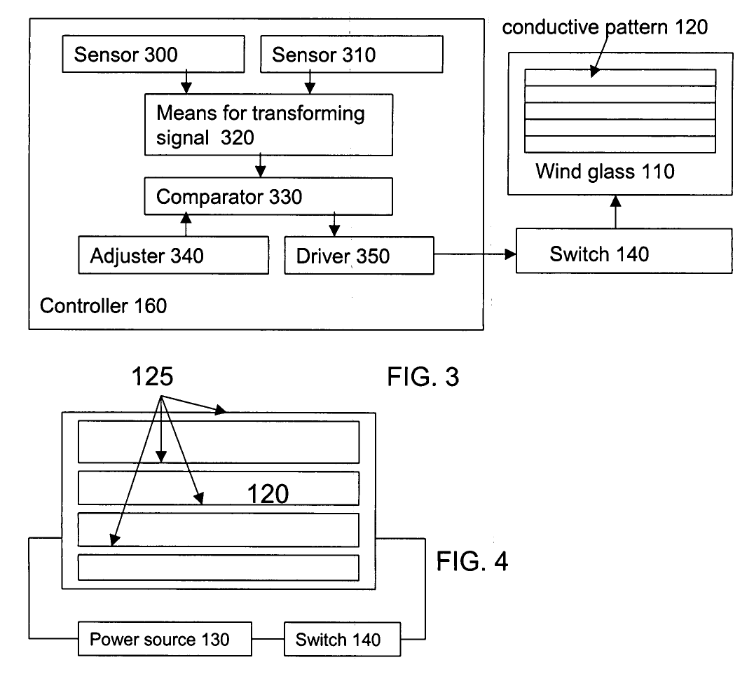

Turning to FIG. 3, the present invention further includes a controller 160 or 260 coupled to the switch, in the case corresponding to FIG. 1, the controller 160 includes a first sensor 300 for detect the parameter of the glass. The parameter includes temperature of the glass, moisture around the glass, or the resistance of the metal strips. The moisture will alter the resistance of the conductive pattern or traces. A second sensor 310 may be used to detect the temperature of the environment. A transformer 320 is coupled to the first and second sensor 300, 310 to transform the collected data into signal. A comparator 330 is coupled to the transformer and responsive the collected data to compare the detected data to a predetermined reference value. An adjuster 340 maybe optional coupled to the comparator to set the predetermined reference parameter or value. A driver 350 is coupled to the comparator 330 to turn on the switch when the detected parameter excesses the predetermined reference parameter, otherwise, turn off the switch. For example, if the detected moisture is higher than the predetermined reference moisture, the power source will provide heat to the conductive strips.

The configuration is fed with a conductor structure as well know in the art. The optically transparent conductive pattern is attached on a transparent substrate like the window of a building, rearview mirror, windshield a vehicle. Windshield or any vehicle windows in general is an adequate position to place this present invention. The transparent conductive pattern includes oxide containing metal, wherein the metal can be selected two or more from Au, Ag, Pt, In, Ga, Al, Sn, Ge, Sb, Bi, Zn, and Pd. Some conductive materials formed by the method are transparent, if the pattern is attached on the glass or window, one may see through the window or glass.

In this case, the conductive layer, usually composed by a material includes oxide containing metal, wherein said metal is preferable to select two or more metals from In, Ga, Al, Sn, Ge, Sb, Bi, Zn, Au, Ag, Pt and Pd. For example, the transparent antenna includes oxide containing indium and tin (ITO). The material of the transparent antenna may include oxide containing Zn or oxide containing Zn with Al2O3 doped therein, oxide containing Sn (SnO2 or SnO), oxide containing Ru, AZO. This shape is constructed by using an adequate mask during the forming process of the transparent conducting layer.

The conventional means is formed by metal trace such as copper or alloy, the film is not optical transparent. Thus, it will cause visual barrier when it attaches on the window glass or glass door. The advantage of using the techniques described in the present invention is that attaching the pattern in the same transparent window such that the moisture can be reduced when the power is fed into the transparent film. The pattern will not cause the visual barrier due to the transparent can be higher than 82% even 90% Other configurations of pattern can be used as well within the same scope and spirit of the present invention.

The method for forming the transparent conductive layer includes ion beam method for film formation at low temperature, for example, the film can be formed with receptivity lower than 3×10⁻⁴ Ω.cm at room temperature. Further, the RF magnetron sputtered thin film method could also be used. The transparent can be higher than 82% It is well known in the field of forming thin film. Under the cost and production consideration, the method for forming the film, for example, indium tin oxide, could be formed at room temperature in wet atmosphere has an amorphous state, a desired pattern can be obtained at a high etching rate. After the film is formed and patterned, it is thermally treated at a temperature of about between 180 degree C. and 220 degree C. for about one hour to three hours to lower the film resistance and enhance its transmittance.

Another preferred formation method is chemical solution coating method. It is preferred due to lower cost and cheaper for the manufacture equipment. The coating solution includes particles having an average particle diameter of 1 to 25 μm, silica particles having an average particle diameter of 1 to 25 μm, and a solvent. The silica particles are optional for reducing the resistance of the conductive film. If the silica particles are introduced, the weight ratio of the silica particles to the conductive particles is preferably in the range of 0.1 to 1. The conductive particles are preferably metallic particles of one or more metals selected from Au, Ag, Pd, Pt, Rh, Ru, Cu, Fe, Ni, Co, Sn, Ti, In, Al, Ta and Sb. The conductive particles can be obtained by reducing a salt of at least one of the above metals in an alcohol/water mixed solvent. Other suitable solvent could be used. Heat treatment is performed at a temperature of higher than about 90 degree C. The metallic particles are approximately contained in amounts of 0.1 to 5% by weight in the conductive film coating liquid.

The transparent conductive film can be formed by applying the liquid solution for forming the layer on a substrate, drying it to form a transparent conductive layer to form a transparent film on the particle layer. The coating liquid for forming a transparent conductive layer is applied onto a substrate by dipping, spinning, spraying, roll coating, printing or the like and then drying the liquid at a temperature of room temperature to about 90.degree. C. After drying, the coating film is curing by heated at a temperature of not lower than 100 degree C. or irradiated with an electromagnetic wave or in the gas atmosphere. A passivation layer can be coated on the transparent conductive film. Materials for this passivation layer are made, for instance, of oxide, or any other polymeric material, polymer, resin coating on the structure.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

1. A moisture removal device comprising:
a transparent conductive pattern formed on a windshield, a rear view mirror or a wind glass of a vehicle allowing for minimum reduction of visibility through said windshield, said rear view mirror or said wind glass, wherein said transparent conductive pattern is fonxed by preparing a coating solution having metal selected from Au, Ag, Pd, Pt, Rh, Ru, Cu, Fe, Ni, Co, Sn, Ti, In, Al, Ta, Sb and the combination thereof and optional silica particles, followed by applying said coating solution on a substrate, then drying and curing by heating at a temperature or irradiating with an electromagnetic wave or in a gas atmosphere;
a power source coupled to said transparent conductive pattern for providing power to remove moisture on said object; and
a switch coupled between said power source and transparent conductive pattern to control the status of said moisture removal device.

2. The device of claim 1, wherein the material of said transparent conductive pattern includes oxide containing indium and tin (ITO).

3. The device of claim 1, wherein the material of said transparent conductive pattern includes oxide containing Zn or oxide containing Zn with Al₂O₃ doped therein.

4. The device of claim 1, wherein the material of said transparent conductive pattern includes oxide containing Sn (SnO₂ or SnO).

5. The device of claim 1, wherein the material of said transparent conductive pattern includes oxide containing Ru.

6. The device of claim 1, wherein said metal has an average particle diameter of 1 to 25 μm, and said silica particles have an average particle diameter of 1 to 25 μm.

7. The device of claim 1, wherein said transparent conductive pattern is constructed by a plurality of strips.

8. The device of claim 7, wherein said plurality of strips is connected together via each two terminals of said plurality of strips.

9. The device of claim 1, wherein said transparent conductive pattern is constructed by polygonal pattern.

10. The device of claim 1, wherein weight ratio of said silica particles to the particles of said metal is in the range of 0.1 to 1.

11. The device of claim 1, wherein the particles of said metal is obtained by reducing a salt of at least one of the above metals in an alcohol/water mixed solvent.

12-14. (canceled)

15. The device of claim 1, wherein said moisture removal device further comprising a controller coupled to said switch, said controller includes: a sensor to detect a parameter of said windshield, said rear view mirror or said wind glass; a comparator is responsive to said detected data and comparing to a predetermined reference value; a driver is coupled to said comparator to control the state of said switch, wherein when said detected data excesses said predetermined reference parameter, said switch being turned on, otherwise, being turning off.

16. The device of claim 15, wherein said parameter includes the temperature of the glass, the moisture around the glass, or the resistance of said transparent conductive pattern.

17. The device of claim 1, wherein a passivation layer is coated on said transparent conductive pattern.

18. The device of claim 1, wherein the material for said passivation layer includes oxide, polymeric material, polymer, resin.

19. A moisture removal device comprising:
a transparent conductive pattern formed on a glass or freezer allowing for minimum reduction of visibility through said glass or freezer, wherein said transparent conductive pattern is formed by preparing a coating solution having metal selected from Au, Ag, Pd, Pt, Rh, Ru, Cu, Fe, Ni, Co, Sri, Ti, In, Al, Ta, Sb and the combination thereof and optional silica particles, followed by applying said coating solution on a substrate, then drying and curing by heating at a temperature or irradiating with an electromagnetic wave or in a gas atmosphere;
a power source coupled to said transparent conductive pattern for providing power to remove moisture on said glass or freezer; and
a switch coupled between said power and transparent conductive pattern to control on/off state of said moisture removal device.

20-21. (canceled)

22. The device of claim 19, wherein said moisture removal device further comprising a controller coupled to said switch, said controller includes: a sensor to detect a parameter of said object; a comparator is responsive to said detected data and comparing to a predetermined reference value; a driver is coupled to said comparator to control the state of said switch, wherein when said detected data excesses said predetermined reference parameter, said switch being turned on, otherwise, being turning off.

23. The device of claim 22, wherein said parameter includes the temperature of the glass, the moisture around the glass, or the resistance of said transparent conductive pattern.

24. The device of claim 19, wherein a passivation layer is coated on said transparent conductive pattern.

25. The device of claim 19, wherein the material for said passivation layer includes oxide, polymeric material, polymer, resin.

26. The device of claim 19, wherein said metal has an average particle diameter of 1 to 25 μm, and said silica particles have an average particle diameter of 1 to 25 μm.

27. The device of claim 19, wherein the weight ratio of said silica particles to the particles of said metal is in the range of 0.1 to 1.

28. The device of claim 19, wherein said the particles of said metal is obtained by reducing a salt of at least one of the above metals in an alcohol/water mixed solvent.
